(19) United States
(12) Patent Application Publication
(10) Pub. No.: US 2003/0043813 A1
(43) Pub. Date: Mar. 6, 2003

(54) Distribution of weightings between port control system and switch cards of a packet switching device

(76) Inventors: Andries Van Wageningen, Wijlre (NL); Hans Juergen Reumerman, Aachen (DE); Armand M.M. Lelkens, Heerlen (NL); Joern Ungermann, Aachen (DE); Rainer Schoenen, Aachen (DE)

Correspondence Address: U.S. Philips Corporation, 580 White Plains Road, Tarrytown, NY, 10591, US

(21) Appl. No.: 10/232,014

(22) Filed: Aug. 29, 2002

(30) Foreign Application Priority Data
Aug. 31, 2001 (DE) 10142460.4

(51) Int. Cl. H04L 12/28

(52) U.S. Cl. 370/395.4

(57) ABSTRACT

The invention relates to a packet switching device comprising a plurality of line cards (1 and 2), each consisting of a port control system (6 and 7) for storing and arranging packets in output queues and for the clocked generation and amendment of weightings containing information about the states of the output queues, and comprising a plurality of switch cards (3 to 5), each consisting of a crosspoint matrix (8) and an arbiter (9) for controlling the crosspoint matrix (8). Herein, the port control systems (6 and 7) each transmit to the arbiter (9) an amended weighting selected from a Table using a round robin method (30).

The invention relates to a packet switching device comprising a plurality of switch cards.

Since the data transmission rate in networks is increasing greatly, the development of switching devices is leading to an ever higher data throughput. In the publication “Weighted Arbitration Algorithms with Priorities for Input-Queued Switches with 100% Throughput” by R. Schoenen, G. Post, G. Sander, Broadband Switching Symposium '99, various weighted switching algorithms of a packet switching device are compared. The switching algorithms attempt, in different switching stages, to prevent a collision between a plurality of packets destined for the same output port of the packet switching device, and to reduce data loss or delay resulting from this.

A data packet arriving at an input port of the packet switching device is broken down into cells of constant length. Owing to segmentation of the data packets, a clocked switching of the cells can take place. Both the input port control and the output port control systems have buffers for the temporary storage of cells. The cells to be switched are arranged according to priority and the desired output port of the packet switching device, whereby the arrangements of the packets according to priority and a desired output port are designated virtual output queues (VOQ).

Together with the cells, weightings are sent to the switch cards to inform the switch card of the output port for which the cell is destined. The sending of the cells together with the weightings to the switch card is restricted by a constant bandwidth of the connections.

A packet switching device consists of a plurality of line cards and a plurality of switch cards. Among the components of a line card is the port control system, an important component. Each port control system is connected to a plurality of switch cards operating in parallel and has the task of arranging cells to be switched, as they arrive at the packet switching device, according to priority and the desired output port of the packet switching device.

Furthermore, the port control system generates weightings which each represent a linkage of an input port to an output port. Since the weightings are generated by the port control system, the port control system can inform the arbiter of whether and how urgently the cells present in the input port are to be switched. A weighting can contain information about the priority and class of the cells and/or the waiting time or size of an output queue.

Each switch card consists of a crosspoint matrix and an arbiter. The configuration of the crosspoint matrix is newly determined by the arbiter by clock cycle, creating new linkages between the input and output ports of the packet switching device for switching of the cells.

Since the bandwidth between port control system and arbiter is restricted, the port control system can transfer only a limited number of weightings in each clock cycle of the arbiter. In the case of switching with a plurality of switch cards and a fast-operating port control system, the clock cycle of a port control system will be shorter than in the case of switching with one switch card while the clock cycle of an arbiter remains unchanged.

As a result, several amendments to weightings occur during one clock cycle of an arbiter in the port control system. Since the number of weightings that the port control system of an arbiter can transfer in one clock cycle of the arbiter is restricted (e.g. two), only some of the amended weightings can be transferred to each individual arbiter.

It is an object of the invention to increase the transmission rate of the packet switching device, with a constant bandwidth of the connections between port control system and switch card, by fast-operating port control systems, additional switch cards and a method for distributing information important to the switching operation.

The object is achieved by a packet switching device of the kind specified above in that the port control system is provided for transmitting to the arbiter an amended weighting, selected from a Table using a round robin method.

If an amendment to a weighting has taken place, the amendments to each weighting are stored in a Table. Amendment to the weighting may be due to the fact that a cell from the output queue for switching to the crosspoint matrix has been transmitted, or a cell arriving at the input port has been inserted into the output queue.

The amended weighting to be transmitted to the arbiter is determined from the Table by a round robin method as an operator strategy (scheduling) from the Table. The round robin method is used in cases where a plurality of competing processes are aiming to access a resource. Each process is given a limited time in which it can access the resource. On expiry of this time, the next process can take advantage of the resource. A limit is imposed by restricting the bandwidth between port control system and arbiter, which determines the maximum number of weightings that the port control system can transmit to the arbiter in each clock cycle of the arbiter.

The round robin method is not applied to all weightings, but only to the amended ones, and only the amended weightings are transmitted. On implementation of the round robin method, a pointer is used as an aid to refer, for orientation purposes, to a weighting to be sent. Owing to the targeted selection of the weightings to be transmitted, the port control system can operate quickly and insert additional switch cards to increase the transmission rate of the packet switching device.

If none of the weightings has been amended, one of the non-amended weightings is selected and sent by means of a second round robin method. A pointer of the second round robin method is hereby provided for each switch card. The pointer of the second round robin method is incremented when the arbiter of the switch card is ready to receive information sent by a port control system.

Since the amendment of a weighting is retained in the Table, a counter assigned to the weighting in the port control system can count how often the weighting has been transmitted to the arbiter since it was last amended. When the weighting is sent to the arbiter, the number in the counter is increased by one. The number of transmissions is stored by the port control system in the same Table.

On the basis of the number, the port control system determines a priority of the weighting. A low number of transmissions already executed results in a high priority for the weighting. Should the weighting change, the pointer is initialized with a zero. On the basis of the priority of the weighting is determined which weighting is to be transmitted first if the number of amended weightings exceeds the bandwidth of the link between port control system and arbiter. The counter can be used to define the maximum number of transmissions for each amended weighting. If the maximum number of transmissions for each amended weighting is set to one, an amended weighting will be sent to only one of the arbiters as a result.

In a second Table, the port control system stores the most recently transmitted weightings. Using the Table, the port control system creates differences between the most recently sent weightings and the current weightings. From the differences determined for each weighting, a maximum difference is determined and the associated weighting is transmitted to the arbiter.

In addition, a Table is created separately for each arbiter with the weightings already transmitted to this arbiter for each output port. The Table contains the weightings known to the one arbiter. The difference between the weighting most recently transmitted to this arbiter and the current weighting is calculated separately for each output port, and the maximum difference of all the differences is determined. Using the maximum difference, a weighting which will be transmitted to the arbiter can be determined. Should the maximum difference be equal to a plurality of weightings, the first round robin method decides which of the weightings will be transmitted.

The port control system contains information concerning the priority and class of the cell and/or the queuing time or the size of the output queue. The weightings are created from this information. The information is stored separately for each arbiter. Each Table receives part of the information and all the parts of the respective Tables together yield all the information.

A cell arriving at the port control system or a cell departing from the port control system can bring about an amendment to a state (e.g. size) of the output queue in which it was waiting or from which it was removed. The information about this output queue will thereby change and the amendment will be forwarded to one of the Tables of an arbiter. Since the amendment is not noted in all the Tables of all arbiters, a selection must be made of the Table of an arbiter to which the amendment will be forwarded. The selection can be achieved by means of a round robin method.

Since the information on the output queues is stored in parts over several Tables, not all Tables have to be amended. With a complementary distribution of the information over the Tables, each part of the information is stored in only one Table. The amendment of only one Table results in an amendment to the state of an output queue. The selection of a Table can be achieved by means of several methods (e.g. a first and a second round robin, a uniform distribution of the information for each virtual output queue).

On the basis of the information present in the Table of an arbiter, the port control system calculates the weightings for this arbiter. The weightings give rise to very good-quality calculations of the arbiters, thereby increasing the transmission rate of the packet switching device with a constant, low bandwidth of the connection between the port control system and arbiter.

The invention also relates to a port control system of a line card, which arranges and stores packets in output queues, and generates and amends clocked weightings which contain information about states of the output queue. The port control system transmits to the arbiter an amended weighting selected from a Table using a round robin method.

Furthermore, the invention relates to a switching method for a packet switching device comprising a plurality of switch cards and a plurality of line cards. Each switch card consists of a crosspoint matrix and an arbiter for controlling the crosspoint matrix. Each line card consists of at least one port control system, in which the port control system stores and arranges packets in output queues, and generates and amends clocked weightings. The weightings contain information about the states of the output queues. An amended weighting is selected from a Table for transmission to the arbiter using a round robin method.

The invention will be further described with reference to examples of embodiments shown in the drawings to which, however, the invention is not restricted:

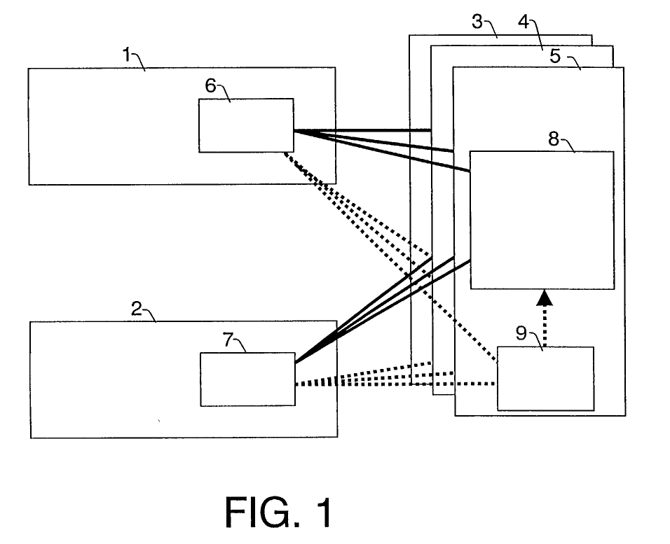

FIG. 1 shows a packet switching device,

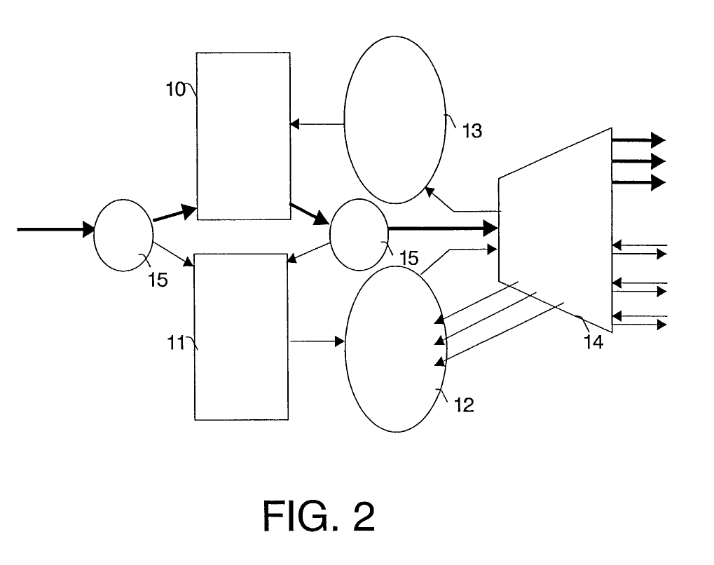

FIG. 2 shows a port control system of an input port,

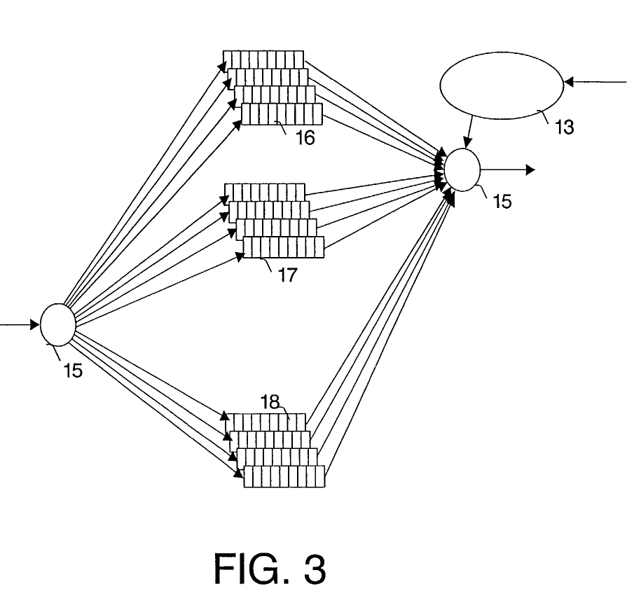

FIG. 3 shows cells arranged in virtual output queues in a port control system according to the desired output port,

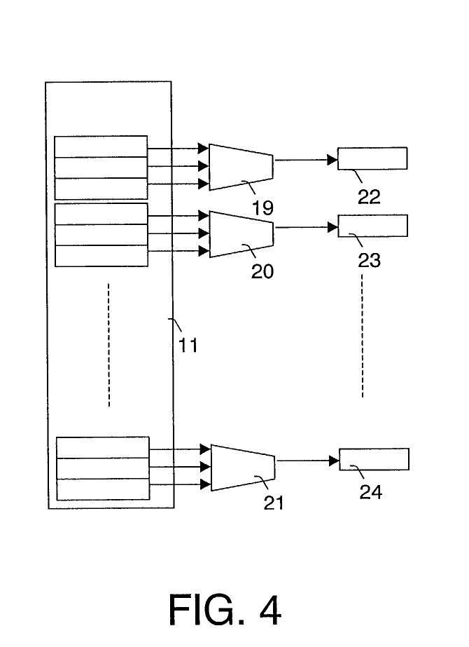

FIG. 4 shows the generation of a plurality of weightings,

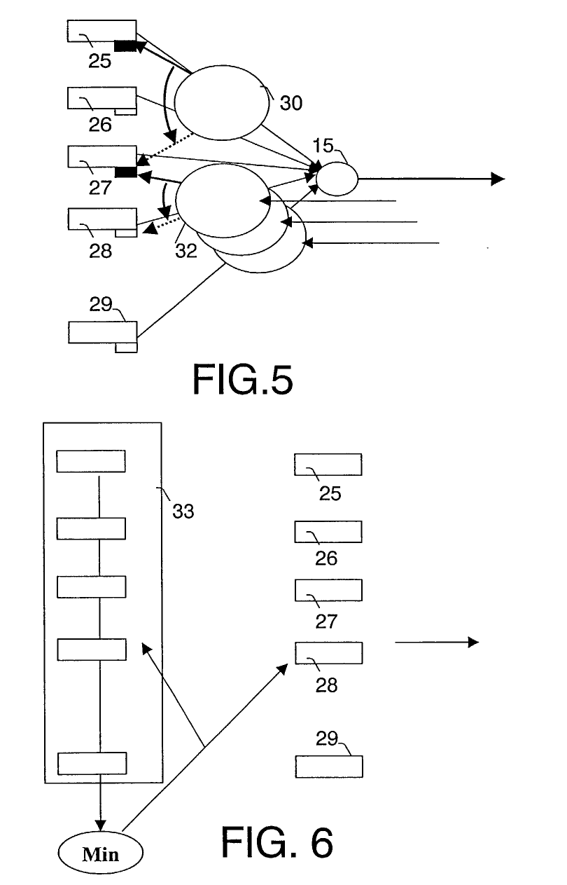

FIG. 5 shows a round robin method as operating strategy,

FIG. 6 shows a Table with a number of transmissions per weighting,

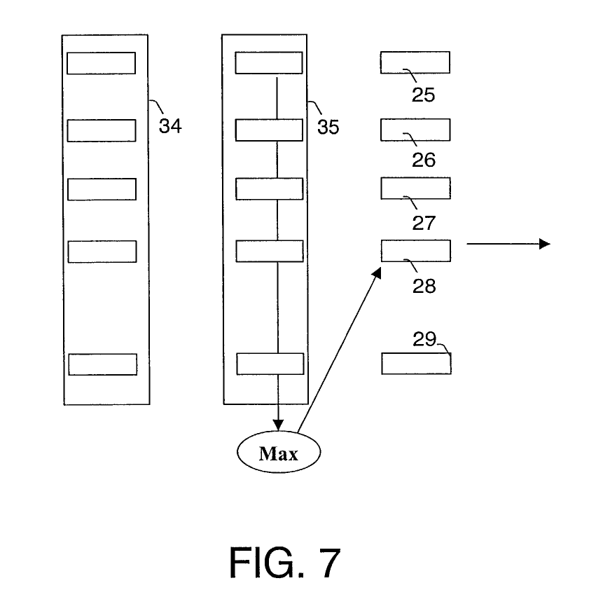

FIG. 7 shows a Table with the most recently transmitted weightings and a second Table with differences between the most recently transmitted and current weightings,

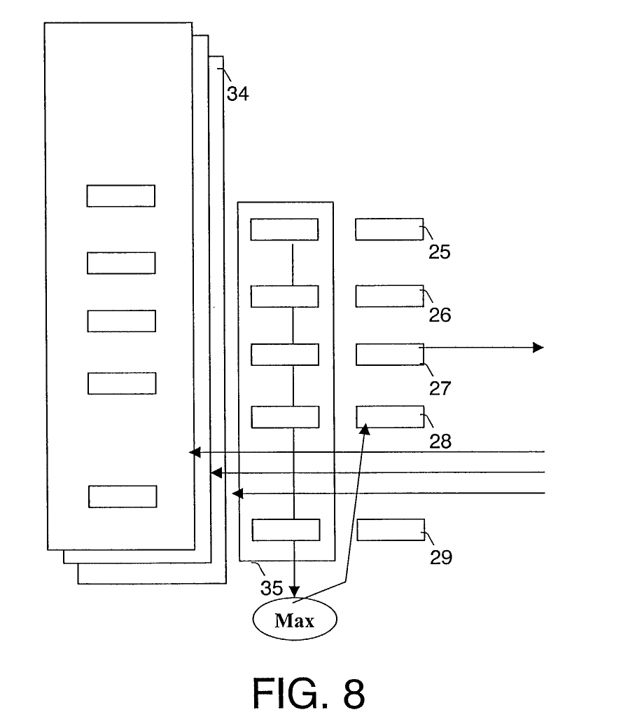

FIG. 8 shows Tables assigned to arbiters, with the most recently transmitted weightings, and a Table with differences between the most recently transmitted and current weightings,

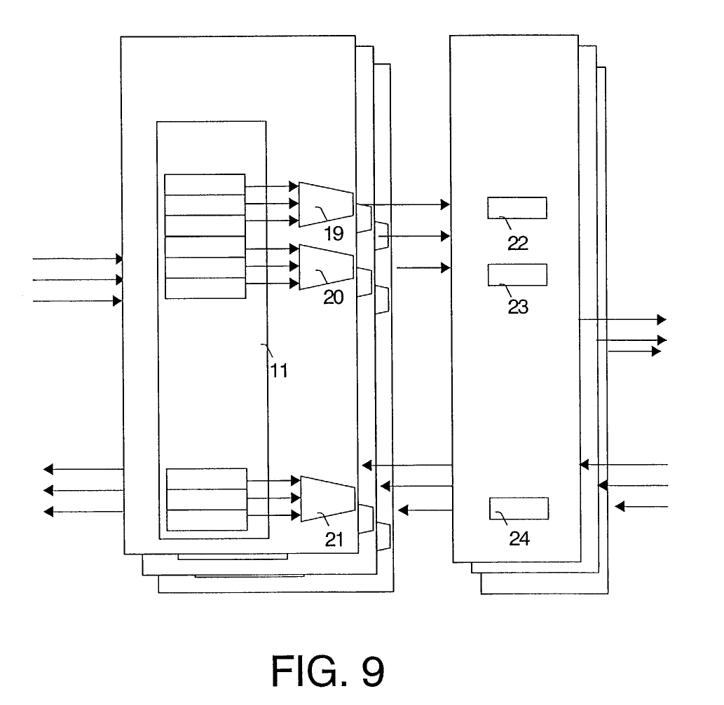

FIG. 9 shows a Table assigned to an arbiter with information and weightings, as well as a Table assigned to an arbiter with the most recently transmitted weightings and differences between the most recently transmitted and current weightings, and

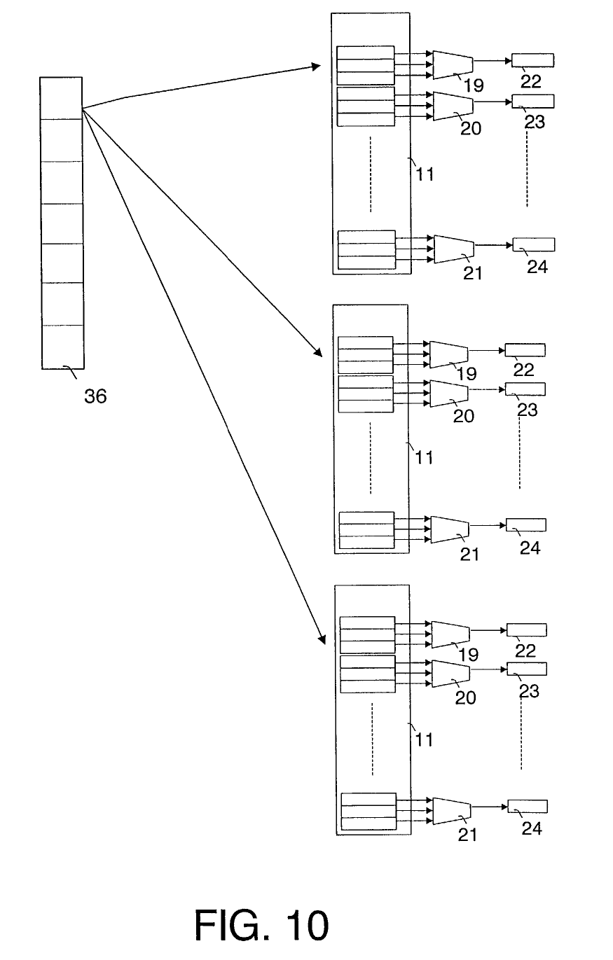

FIG. 10 shows a distribution of information to some Tables assigned to an arbiter.

A packet switching device shown in FIG. 1 consists of two line cards 1 and 2 and a plurality of switch cards 3 to 5. The line cards 1 and 2 consist of various components, such as optical transmission unit, frame generator, network processor etc., which are irrelevant for describing the example of embodiment, and are therefore not shown, as well as a port control system 6 and 7, which is significant for the example of embodiment. The number of port control systems is frequently much greater than two, but in the example of embodiment it has been restricted to two for reasons of clarity. Each switch card 3 to 5 consists of a crosspoint matrix 8 and an arbiter 9. Both the arbiter 9 and the crosspoint matrix 8 of each parallel-operating switch card 3 to 5 are connected to port control system 6 and 7 in each case.

Data packets of constant length are designated cells. As cells of constant length are easier to handle during switching than packets of fluctuating size, the arriving packets are broken down into cells of constant lengths within line cards 1 and 2, and put into temporary storage in output queues. Following successful switching, i.e. accepted assignment of each input port to an output port, the cells are removed from the output queue.

The task of port control system 1 and 2 is to arrange the arriving cells in output queues according to their priority and the desired output port (target output port) of the packet switching device. This arrangement is designated virtual output queuing (VOQ). Using a weighting, the port control system can inform the arbiter whether and how urgently the cells present in the input port are to be switched. A weighting may contain information about the priority and classification of the packets and/or the queuing time or size of an output queue.

The arbiter 9 of each switch card 3 to 5 calculates at regular intervals, known as clock cycles, an optimum configuration of crosspoint matrix 8 for linkage of the input and output ports of the packet switching device. The calculations of arbiter 9 are based on the weightings of port control systems 6 and 7, in which the cells are waiting in output queues to be switched to an output port. The linkage must fulfil two conditions. Within a clock cycle of the switch card, a linkage must not link a plurality of output ports with one input port and/or a plurality of input ports with one output port of the packet switching device. The arbiter 9 contains all the current weightings received by port control system 6 and 7, and in each clock cycle sends the calculated configuration of the crosspoint matrix 8 to port control system 6 and 7 and crosspoint matrix 8.

Since switch cards 3 to 5 are operated in parallel, an operating rate of each switch card 3 to 5 is lower than an internal operating rate of port control system 6 and 7. A clock cycle of switch cards 3 to 5 is thereby longer than an internal clock cycle of port control system 1 and 2. Since port control systems 1 and 2 are simultaneously connected to a plurality of switch cards 3 to 5, they require an interface that can be operated simultaneously with a plurality of switch cards 3 to 5. The internal operating rate of port control systems 6 and 7 has three times the value of the operating rate of a switch card 3 to 5.

On receipt of the configuration calculated by arbiter 9 and thereby of the linkages, the port control system is aware of the switch cards 3 to 5 to which connection will be made in the next clock cycle of the switch card.

A port control system of an input port shown in FIG. 2 consists of a storage unit 10 for storing virtual output queues (VOQs), a second storage unit 11 for storing states of the VOQS, and a first and second decision unit (12 and 13). The first decision unit 12 determines which of the weightings are sent to the arbiter, and the second decision unit 13 decides which of the cells stored in the port control system are sent to the previously selected output port. The port control system has an interface 14, which ensures a linkage to a plurality of arbiters and a plurality of crosspoint matrices.

A cell 15 reaching the input port is stored in VOQs in the first storage unit 10 by port control system 6 as a function of its priority and target output port. Simultaneously, the state of the VOQ amended by the arriving cell is stored in storage unit 11.

The VOQs are described by states. The state of a VOQ can express a length or size of the VOQ. The states of the VOQ are stored in the second storage unit 11. On the basis of the states, the first decision unit 10 selects a weighting which is sent to arbiter 9 through interface 14.

A result (grant) transmitted by arbiter 9 to interface 14 indicates the output port to which the port control system may transmit the cell 15. Assigned to the result by decision unit 13 is the cell 15, which is switched to the selected output port. Simultaneously, the state of the VOQ amended by the switched cell is stored in storage unit 11. Following the switching, the cell is removed from storage unit 10.

FIG. 3 shows a plurality of VOQs 16 to 18, which are stored in storage unit 10. VOQs 16 contain cells which have specified an output port 01 as the target output port. VOQs 17 contain cells that are to be switched to target output port 02, and VOQs 18 contain cells that have specified an output port 03 as the target output port. The number of input and output ports is restricted to three, but can reach a value of 64, for example.

Depending on its target output port, the cell 15 arriving at port control system 6 is arranged into one of the VOQs 16 to 18. The result transmitted by an arbiter 9 is used by decision unit 13 to switch cell 15 from one of the VOQs 16 to 18 to the selected output port.

FIG. 4 clarifies a generation of weightings 22 to 24. Each generator unit 19 to 21 is assigned to an output port and evaluates the VOQ states stored in storage unit 11 and belonging to this output port.

Using the VOQ states stored in storage unit 11, generator unit 19 calculates a weighting 22. By analogy, weighting 23 is determined by generator unit 20, and weighting 24 by generator unit 21, using the relevant states of the VOQS. Determination of weightings 22 to 24 depends on the function executed by generators 19 to 21.

FIG. 5 shows two operating strategies, a first round robin method 30 and a second round robin method 32, which select a weighting 25 to 29 respectively for transmission to the arbiter. Weightings 25 and 27 have been amended thereby, and weightings 26, 28 and 29 have remained unchanged.

From the amended weightings 25 and 27, the first round robin method 30 determines a weighting for transmission to arbiter 9. If no amended weighting is present, the second round robin method 32 decides which of weightings 25 to 29 will be transmitted. In the next clock cycle of port control system 6, the first round robin method 30 determines the currently amended weighting 25 for transmission to arbiter 9.

A pointer of second round robin method 32 is provided for each switch card. The pointer serves both for the first round robin method and for the second round robin method 32 as an aid to marking a weighting. The pointer of the second round robin method 32 is incremented when arbiter 9 of switch card 5 is ready to receive information sent by a port control system 6. The pointer of first round robin method 30 is increased in each clock cycle of port control system 6 to the next amended weighting 27. An increase of the pointer can take place either through multiple incrementation or through a suitable combinatorial logic circuit. With either option, the pointer executes a modulo-N function, whereby N is the number of output ports. The pointer of the first round robin method is not amended if no new weighting is present.

A Table 33 shown in FIG. 6 contains several values which are each assigned to a weighting 25 to 29, and which express a number of transmissions of the weightings 25 to 29 to the arbiter.

By means of a counter in the port control system, a number of transmissions of each weighting to the arbiter 9 can be recorded. When the weighting is transmitted to arbiter 9, the number in the counter is increased by one. The number of transmissions is stored in a Table 33 by the port control system. On the basis of the number, the port control system determines a priority of the weighting. A low number of transmissions already executed results in a high priority of the weighting. The selection of a weighting to be transmitted first is determined by the priority of the weighting.

The port control system determines a minimum number from the values of Table 33. Since Table 33 specifies a minimum number of transmissions for weighting 28, weighting 28 is transmitted to the arbiter 9. If the value of the weighting changes, the counter is initialized with a zero.

The counter can be used to determine a maximum number of transmissions for each amended weighting 25 and 27. If the maximum number of transmissions for each amended weighting 25 and 27 is defined as one, an amended weighting 25 and 27 is transmitted to only one of the arbiters 9. As a result, the counter can be realized with a single bit. If the amendment on transmission of the weighting is taken from the Table or reset to unamended, the counter is not necessary.

FIG. 7 shows two Tables 34 and 35. Table 34 contains a plurality of most recently transmitted weightings for each output port, which have been transmitted to the arbiters 9 of each switch card. Table 35 consists of differences which have been determined in each case between a most recently transmitted weighting and a current weighting 25 to 29.

In Table 34, the port control system stores the most recently transmitted weightings. Using the Table, the port control system forms a difference between the most recently transmitted weighting and the current weighting 25 to 29. Like the weightings 25 to 29, the differences are each assigned to an output port. From the differences determined, a maximum difference, corresponding to weighting 28, is determined. The associated weighting 28 is then sent to the arbiter.

FIG. 8 shows several Tables 34. Each Table 34 is assigned to an arbiter 9. For each arbiter 9, the weighting of each output port that was most recently transmitted to this arbiter is stored in one of the Tables 34. In this way, each Table 34 receives the weightings known to the relevant arbiter 9.

The differences between each most recently sent weighting and the current weighting 25 to 29 are calculated using the particular Table 34 associated with the arbiter 9. As for the weightings 25 to 29, the differences are each assigned to an output port. From the differences determined, a maximum difference, corresponding to weighting 28, is determined. The associated weighting 28 is then sent to the associated arbiter.

FIG. 9 shows a plurality of storage units 11, which are each assigned to an arbiter and which contain certain states of the VOQs assigned to the particular arbiter 9. Tables 34 and 35 are each assigned to an arbiter 9.

Using the states of the VOQs of each storage unit 10, the generators 19 to 21 calculate for each arbiter 9 the current weightings 22 to 24. For each arbiter 9, the weighting most recently transmitted to arbiter 9 is recorded in Table 34 for each output port. The port control system determines for each arbiter 9 the maximum difference from the differences in Table 35 between the current weightings 22 to 24 and the associated most recently transmitted weightings of Table 34, and transmits the associated weighting to the arbiter 9.

FIG. 10 shows a distribution of the amendments of the states of the VOQ. The current states of the VOQ, distributed over a plurality of storage units 11, are stored in Table 36 in each clock cycle. Each storage unit 11 contains part of the information about the states of the VOQ which are assigned to this arbiter 9 in each case. For each VOQ, part of an overall state is stored separately in each arbiter 9. The parts of the states supplement each other in a complementary fashion so that no two parts contain the same information.

Using the example of an overall value of the VOQ, this would be divided into partial values, whereby a sum of the partial values corresponds to an overall value of the VOQ. Using the example of the queuing time of a cell in the VOQ, an overall sum of queuing times of the VOQ would be divided into partial values.

On the basis of the information contained in each storage unit 11, the generator units 19 to 21 calculate the weightings 22 to 24 for each arbiter.

A cell arriving at or departing from the port control system may result in an amendment to the VOQ in which it is incorporated or from which it is removed. The entire state of the VOQ is thereby amended, and the amendment is forwarded to one of the storage units 11 of an arbiter 9 in order to amend one part of a state. As the amendment is not noted in all storage units of all arbiters, the storage unit 11 of an arbiter at which the VOQ state is to be amended must be selected. The selection can take place by several methods.

The selection can be made by a single round robin method. There are several options for doing this:

1. In each clock cycle of the port control system, the pointer of the round robin method refers to the next storage unit 11.

2. For each cell arriving at the port control system, the pointer of the round robin method is referred to the next storage unit 11.

3. The pointer of the round robin method refers to the next storage unit 11.

4. For each individual amendment of the overall state, the pointer of the round robin method is referred to the next storage unit 11.

The selection can be made by a second round robin method. The first round robin method hereby relates to the input port of the port control system and the second round robin method to switch cards 3 to 4. The options for executing the first round robin method are as follows:

1. In each clock cycle of the port control system, the pointer of the round robin method refers to the next storage unit 11.

2. For each arriving cell, the pointer refers to the next storage unit 11. A period of time that is needed for converting the amendment of a state into an assignment of the pointer can be shortened in that the amendment is executed within the storage unit 11 and its pointer is the first to be ready to execute a new assignment. This method can be applied either to the amendments brought about by a switching operation, or to amendments brought about by arriving cells, or to both amendments simultaneously.

A further method is aimed at a uniform distribution of the individual, distributed states of each VOQ.

The overall value of a VOQ is 12. If the partial values for the VOQ in each of a total of four storage units 11 are all three, the state of this VOQ is uniformly distributed. Since the state of a VOQ is increased with each arriving cell and the state of a VOQ is reduced with each switching operation, the selection of storage unit 11 is made by means of the following methods:

1. For each arriving cell, the storage unit 11 in which the VOQ state is smallest is selected. Should a plurality of VOQ states be equally small simultaneously, it is additionally determined by means of the round robin method which of these smallest VOQ states is selected.

2. For each switching operation of a cell, the storage unit 11 in which the VOQ state is largest is selected. Should a plurality of VOQ states be equally large, it is additionally determined by means of the round robin method which of these largest VOQ states is selected.

The value of a VOQ state can be determined from, for example, the value of the VOQ, or from the number of queuing periods of the cells of this VOQ.

1. A packet switching device comprising a plurality of line cards (1 and 2), each consisting of a port control system (6 and 7) for storing and arranging packets in output queues and for the clocked generating and amending of weightings containing information about the states of the output queues, and comprising a plurality of switch cards (3 to 5), each consisting of a crosspoint matrix (8) and an arbiter (9) for controlling the crosspoint matrix (8), the port control systems (6 and 7) being each provided for transmitting to the arbiter (9) an amended weighting selected from a Table using a round robin method (30).

2. A packet switching device as claimed in claim 1, characterized in that the port control system (6 and 7) is provided for selecting by means of a second round robin method (32) a weighting for transmission to the arbiter (9) if no amended weighting is present, and in that a pointer of the second round robin method (32) is provided in each switch card for marking a weighting, and in that the pointer is incremented when the arbiter of the switch card is ready to receive information.

3. A packet switching device as claimed in claim 2, characterized in that
a counter assigned to each weighting is provided in the port control system (6 and 7) for counting the transmissions of the weighting to the arbiter since a most recent amendment to the weighting,
in that the port control system (6 and 7) is provided for storing a number of transmissions in the Table,
and in that the port control system (6 and 7) is provided for determining the priority of the weighting as a function of the number of transmissions and for transmitting the weighting having the highest priority to the arbiter (9), and
in that the number of transmissions since a most recent amendment of the weighting can be restricted.

4. A packet switching device as claimed in claim 3, characterized in that the port control system is provided for storing a second Table (34), which contains the most recently transmitted weighting for each output port, and in that the port control system is provided for determining a difference between the transmitted and the current weightings and for determining a maximum difference between the weightings.

5. A packet switching device as claimed in claim 4, characterized in that a separate Table (34) with the weightings most recently transmitted to the arbiter is provided for each output port, and in that the port control system is provided for determining a difference and determining a maximum difference between a current weighting and the weighting most recently transmitted to the arbiter.

6. A packet switching device as claimed in claim 4, characterized in that the port control system (6 and 7) is provided for storing a Table with information for each arbiter separately, in that amendments to the information are distributed over the Tables with information of the arbiters, and in that the port control system (6 and 7) is provided with information from the separate Table for generating the weightings for each arbiter.

7. A port control system (6 and 7) of a line card (1 and 2)
for storing and arranging packets in output queues and
for the clocked generation and amendment of weightings containing information about states of the output queues,
and for transmitting to the arbiter (9) an amended weighting selected from a Table by means of a round robin method (30).

8. A switching method for a packet switching device comprising a plurality of switch cards (3 to 5), each consisting of a crosspoint matrix (8) and an arbiter (9) for controlling the crosspoint matrix (8) and a plurality of line cards (1 and 2), each consisting of a port control system (6 and 7), in which in the port control system (6 and 7),
packets are arranged and stored in output queues,
clocked weightings containing information about the states of the output queues are generated and amended,
and an amended weighting is selected from a Table for transmission to the arbiter (9) using a round robin method (30).
